(19) United States
(12) Patent Application Publication
(10) Pub. No.: US 2023/0169488 A1
(43) Pub. Date: Jun. 1, 2023

(54) APPARATUS AND SERVER FOR ELECTRONIC PAYMENT, AND METHOD FOR ELECTRONIC PAYMENT USING THE SAME

(71) Applicants: HYUNDAI MOTOR COMPANY, Seoul (KR); Kia Corporation, Seoul (KR)

(72) Inventor: Yong Woo SHIN, Yongin-si (KR)

(73) Assignees: HYUNDAI MOTOR COMPANY, Seoul (KR); Kia Corporation, Seoul (KR)

(21) Appl. No.: 17/897,582

(22) Filed: Aug. 29, 2022

(30) Foreign Application Priority Data
Nov. 30, 2021 (KR) 10-2021-0169155

(51) Int. Cl. G06Q 20/32; G06Q 20/12

(52) U.S. Cl. CPC G06Q 20/3267; G06Q 20/12

(57) ABSTRACT

According to an embodiment of the present disclosure, an electronic payment apparatus may include a head unit for providing a user interface (UI) of a payment app that makes an electronic payment and a controller that activates the payment app based on a fact that first version information of the payment app is identical to first version information of a service version stored in a server, makes a request for a franchisee list, at which it is possible to make a payment with the payment app, to the server based on a fact that the payment app is activated, makes a request for UI information of a target store selected from the franchisee list to the server, generates a UI based on the UI information received from the server, and makes the electronic payment based on the UI displayed on the head unit.

### CROSS-REFERENCE TO RELATED APPLICATION

The present application claims priority to Korean Patent Application No. 10-2021-0169155, filed on Nov. 30, 2021, the entire contents of which are incorporated herein for all purposes by this reference.

### TECHNICAL FIELD

The present disclosure relates to an apparatus and a server for electronic payment, an electronic payment method using the same, and more particularly, relate to a technology capable of coping with changing service situations through version management.

### BACKGROUND

Vehicles are being used in various forms in real life as well as being used as a means of transportation. With the development of displays and electronic devices, vehicles may aggressively use multimedia through a head unit. Moreover, with the development of communication, communication between a vehicle and an external device or a server is getting easier.

Online shopping means have expanded from personal computers to personal terminals. Nowadays, online shopping has been applied through a vehicle's head unit. Online shopping using a vehicle may allow a user to make electronic payments more easily in conjunction with a driving convenience device while the user boards the vehicle.

Unlike the update of other mobile terminals, it is not easy to update the vehicle's software, and thus users tend to be indifferent to the software upgrade of the vehicle. Accordingly, when a software version installed in the vehicle is different from the version of a server supporting the electronic payment upon making an electronic payment by using the vehicle, it may be impossible to make an electronic payment. When a user's electronic payment is impossible because a service version is upgraded due to minor changes in the server, the user may frequently feel uncomfortable.

### SUMMARY

The present disclosure has been made to solve the above-mentioned problems occurring in the prior art while advantages achieved by the prior art are maintained intact.

An aspect of the present disclosure provides an apparatus and server for an electronic payment that are capable of providing an electronic payment service by actively coping with the upgrade of a service version in the server even when a vehicle's software has not been upgraded, and an electronic payment method using the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for an electronic payment may include a head unit for providing a user interface (UI) of a payment app that makes an electronic payment and a controller that activates the payment app based on a fact that first version information of the payment app is identical to first version information of a service version stored in a server, makes a request for a franchisee list, at which it is possible to make a payment with the payment app, to the server based on a fact that the payment app is activated, makes a request for UI information of a target store selected from the franchisee list to the server, generates a UI based on the UI information received from the server, and makes the electronic payment based on the UI displayed on the head unit.

According to an embodiment of the present disclosure, the controller may make a request for the service version to the server and may identify the first version information of the payment app and the first version information of the service version.

According to an embodiment of the present disclosure, the controller may provide a user of the payment app with a notification that it is impossible to use a payment function, when the first version information of the payment app is different from the first version information of the service version.

According to an embodiment of the present disclosure, the payment app may be installed in a vehicle. The controller may make a request for the service version to the server in response to an ignition-on signal of the vehicle.

According to an embodiment of the present disclosure, the controller may request the franchisee list based on transmitting second version information of the payment app indicating franchisee information, which is available with the payment app, to the server.

According to an embodiment of the present disclosure, the controller may request UI information of the target store based on transmitting third version information of the payment app indicating a payment scenario, which is supportable in the payment app, to the server.

According to an aspect of the present disclosure, a server for an electronic payment may include a database (DB) that provides a space in which a service version supporting an electronic payment device using a payment app and information of a franchisee list group where franchisees are classified, a management device for transmitting first information of the service version for determining activation of the payment app to the electronic payment device and to extract a franchisee list from the franchisee list group in response to a franchisee list request from the electronic payment device, and a UI generation device that receives information about a target store selected from the franchisee list from the electronic payment device, generates UI information about the target store, and provides the generated UI information to the electronic payment device.

According to an embodiment of the present disclosure, the management device may update first information of the service version to block service use for the payment app of an existing version.

According to an embodiment of the present disclosure, the management device may identify second information of the payment app received from the electronic payment device in response to the franchisee list request and may extract a franchisee list, which matches second version information of the payment app, from the franchisee list group.

According to an embodiment of the present disclosure, the management device may update second version information of the service version based on a fact that a new franchisee in the franchisee list group is not capable of being serviced in the payment app.

According to an embodiment of the present disclosure, the UI generation device may generate the UI information based on third version information of the payment app indicating a payment scenario, which is supportable in the payment app.

According to an embodiment of the present disclosure, the UI generation device may make a request for service data to the target store and may generate a UI based on the payment scenario and the service data of the target store.

According to an aspect of the present disclosure, an electronic payment method may include activating a payment app based on a fact that first version information of the payment app for an electronic payment is identical to first version information of a service version stored in a server, making a request for a franchisee list, at which it is possible to make a payment in the payment app, to the server based on a fact that the payment app is activated, receiving the franchisee list and making a request for UI information of a target store selected from the franchisee list to the server, and generating a UI based on the UI information received from the server and making an electronic payment based on the UI.

According to an embodiment of the present disclosure, the activating of the payment app may include making a request for the service version to the server and identifying the first version information of the payment app and the first version information of the service version.

According to an embodiment of the present disclosure, the identifying of the first version information of the service version may further include providing a user of the payment app with a notification that it is impossible to use a payment function, when the first version information of the payment app is different from the first version information of the service version.

According to an embodiment of the present disclosure, the making of the request for the service version to the server may be performed in response to an ignition-on signal of a vehicle in which the payment app is installed.

According to an embodiment of the present disclosure, the making of the request for the franchisee list may include transmitting second version information of the payment app indicating franchisee information, which is capable of being used by the payment app, to the server.

According to an embodiment of the present disclosure, the franchisee list may be generated by extracting a franchisee list matching the second version information of the payment app from a franchisee list group stored in the server.

According to an embodiment of the present disclosure, the making of the request for the UI information of the target store may include transmitting third version information of the payment app indicating a payment scenario supportable in the payment app.

According to an embodiment of the present disclosure, the UI may be generated based on the payment scenario and service data of the target store.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram illustrating a configuration of an electronic payment system, according to an embodiment of the present disclosure.

FIG. 2 is a flowchart illustrating an electronic payment method, according to an embodiment of the present disclosure.

FIG. 3 is a flowchart illustrating an electronic payment method, according to another embodiment of the present disclosure.

FIG. 4 is a view illustrating an embodiment of a message indicating recommendation of a software update.

FIG. 5 is a flowchart illustrating an electronic payment method, according to another embodiment of the present disclosure.

FIG. 6 is a view for describing a method in which a server generates a franchisee list.

FIG. 7 is a view illustrating an embodiment in which an electronic payment device displays a franchisee list.

FIGS. 8 and 9 are diagrams illustrating an embodiment of a UI generated by an electronic payment device.

FIG. 10 is a flowchart illustrating a method for managing version information of a service version for an electronic payment, according to an embodiment of the present disclosure.

FIG. 11 is a block diagram illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

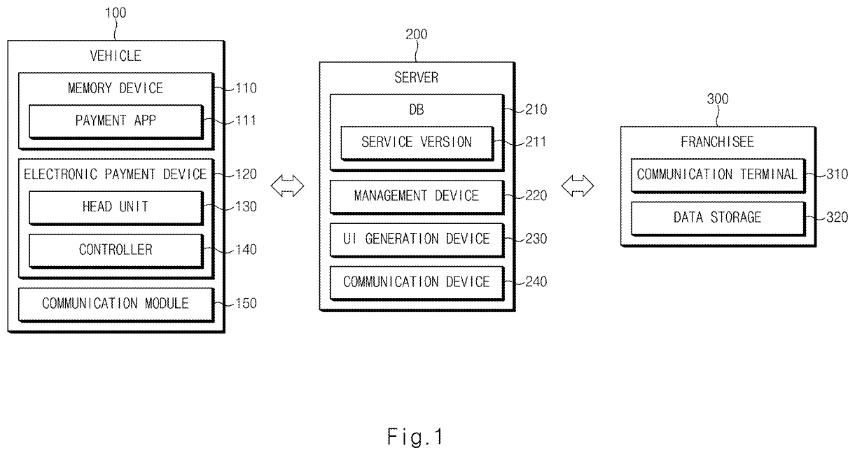

Hereinafter, various embodiments of the present disclosure will be described in detail with reference to FIGS. 1 to 11.

FIG. 1 is a block diagram illustrating a configuration of an electronic payment system, according to an embodiment of the present disclosure.

Referring to FIG. 1, an electronic payment system according to an embodiment of the present disclosure may include a vehicle 100 in which an electronic payment device 120 is mounted, a server 200, and a franchisee 300. Hereinafter, the present specification is mainly described in an embodiment in which the electronic payment device 120 is mounted on the vehicle 100. However, the electronic payment device 120 according to an embodiment of the present disclosure is not limited to being mounted on the vehicle 100.

The vehicle 100 may include a memory device 110, the electronic payment device 120, and a communication module 150. The electronic payment device 120 may include a head unit 130 and a controller 140.

The memory device 110 may provide an area in which a payment app 111 is stored. The payment app 111 may be an application program for making an electronic payment. The payment app 111 may include version information for identifying a version state of the payment app 111. The version information of the payment app 111 may include first version information (X), second version information (Y), and third version information (Z). The first version information (X) may be information for determining whether the payment app 111 is available. The second version information (Y) may be information for identifying a franchisee capable of being serviced through the payment app 111. The third version information (Z) may be information for determining a payment scenario. A payment scenario may be a criterion for identifying a purchase method or a payment method.

The first version information (X), the second version information (Y), and the third version information (Z) are used to identify a version, and may be numbers expressed in a digital format. In the present specification, the first version information may be referred to as “X”, the second version information may be referred to as “Y”, and, the third version information may be referred to as “Z”. Accordingly, the version information may be stored and managed in a format of (X, Y, Z).

The memory device 110 may be provided in the controller 140 and may be a separate memory. The memory device 110 may be implemented with a combination of a nonvolatile memory, such as a hard disk drive, a flash memory, an electrically erasable programmable read-only memory (EEPROM), a ferro-electric RAM (FRAM), a phase-change RAM (PRAM), or a Magnetic RAM (MRAM), and/or a volatile memory, such as a static random access memory (SRAM), a dynamic RAM (DRAM), a synchronous DRAM (SDRAM), or a double date rate-SDRAM (DDR-SDRAM).

The head unit 130 of the electronic payment device 120 may include a radio broadcast reception module, an audio module that plays a voice file stored in a storage medium or a voice source provided from the outside, a video module that plays a video file stored in a storage medium or an image source provided from outside, and a navigation system that guides a route of the vehicle by using GPS information. Furthermore, the head unit 130 may display a user interface (UI) of the payment app 111 and may receive an input from a user. To this end, the head unit 130 may include a display combined with a touch panel.

The controller 140 may determine whether to activate the payment app 111 by comparing the first version information (X) of the payment app 111 with the first version information (X) of a service version 211 stored in the server 200. The controller 140 may display a franchisee list received from the server 200 through the head unit 130. The controller 140 may display a UI for an electronic payment for a target store received from the server 200 through the head unit 130.

The communication module 150 may communicate with the server 200 by using wireless communication. The communication module 150 may transmit and receive a wireless signal with at least one of a base station, an external terminal, and a center on a mobile communication network established depending on technical standards or communication methods for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like). The wireless signal may include various types of data according to transmission/reception of a voice call signal, a video call signal, or a text/multimedia message.

In FIG. 1, the payment app 111 or the communication module 150 may be included in the electronic payment device 120. Besides, the electronic payment device 120 is not limited to an embodiment in which the vehicle 100 is mounted therein, and may be a configuration included in a user terminal or server other than the vehicle 100.

The server 200 may include a communication device 240, a database (DB) 210, and a UI generation device 230.

The DB 210 may provide an area for storing the service version 211.

The service version 211 may be used to support an electronic payment method performed based on the payment app 111 stored in the vehicle 100.

The service version 211 may include first version information (X), second version information (Y), and third version information (Z). The first version information (X) of the service version 211 may be information for determining whether the payment app 111 is available. The first version information (X) of the service version 211 may be updated to prevent the payment app 111 from being used. For example, when the existing payment app 111 no longer needs to be used due to a fatal error in the payment app 111, government policies, or supplementation, the first version information (X) of the service version 211 may be updated. The first version information (X) of the service version 211 may be updated in a method of increasing the number. When the first version information (X) of the service version 211 is updated from ‘i’ (‘i’ is a natural number) to “i+1”, the server 200 may perform a function of preventing activation of the payment app 111 in which the first version information of the service version 211 has a value less than “i+1”.

The second version information (Y) of the service version 211 may be information indicating a franchisee list group that is a service target of an electronic payment. The second version information (Y) of the service version 211 may be updated when there is a change in franchisee information included in the franchisee list group. The second version information (Y) of the service version 211 may be updated in a method of increasing the number. When a franchisee, which is a service target of the payment app 111, is added or deleted, the second version information (Y) of the service version 211 may be updated.

The third version information (Z) of the service version 211 may be information for determining a payment scenario. The payment scenario may be a criterion for identifying a purchase method or a payment method. The third version information (Z) of the service version 211 may be updated when there is a change in the payment scenario. For example, when a payment method of supporting a drive-through electronic payment is newly introduced in the payment app 111, the third version information (Z) of the service version 211 may be updated.

The communication device 240 may wirelessly communicate with the communication module 150 of the vehicle 100 or a communication terminal 310 of the franchisee 300.

The franchisee 300 may be a store that provides goods or services through the payment app 111, and may store and manage service data including store information, menu information of a service target, price information, and the like in data storage 320. In addition, the franchisee 300 may store and manage service scenarios divided based on a payment method, a purchase method, a menu receiving method, or the like, in the data storage 320.

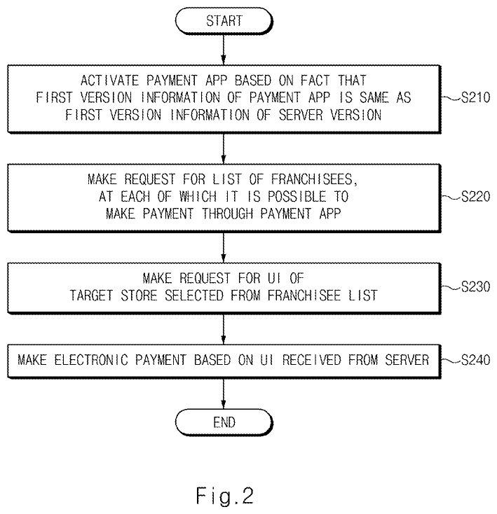

FIG. 2 is a flowchart illustrating an electronic payment method, according to an embodiment of the present disclosure. Hereinafter, according to an embodiment of the present disclosure, an electronic payment method will be described with reference to FIG. 2.

In a first step (S210), the controller 140 of the electronic payment device 120 may determine whether to activate the payment app 111, based on the first version information (X) of the payment app 111. The controller 140 may compare the first version information (X) of the payment app 111 with the first version information (X) of a server version. To this end, the controller 140 may make a request for the version information of a server to the server 200. The controller 140 may activate the payment app 111 based on a fact that the first version information (X) of the payment app 111 is the same as the first version information (X) of the server version.

When the first version information (X) of the payment app 111 is not the same as the first version information (X) of the server version, the controller 140 may deactivate the payment app 111 and may provide a notification message indicating that the payment app 111 is not available, through the head unit 130. Moreover, when the first version information (X) of the payment app 111 is not the same as the first version information (X) of the server version, the controller 140 may provide a message for providing a notification of guiding the update of the payment app 111, through the head unit 130.

In a second step (S220), the controller 140 of the electronic payment device 120 may make a request for a list of franchisees, at each of which it is possible to make a payment through the payment app 111, to an external server through the communication module 150, based on a fact that the payment app 111 is activated. The controller 140 may provide second version information of the payment app 111 for the purpose of requesting the franchisee list. The second version information may be information for determining a franchisee at which the payment app 111 is available.

In a third step (S230), the electronic payment device 120 may receive the franchisee list from the server 200 through the communication module 150. The franchisee list may be generated by extracting the franchisee list matching the second version information (Y) of the payment app 111 from a franchisee list group owned by the server 200.

The controller 140 may display a franchisee list received from the server 200 through the head unit 130.

Moreover, the controller 140 may make a request for UI information of a target store, which is selected through the head unit 130, to the server 200. To this end, the controller 140 may transmit third version information of the payment app 111 to the server 200 through the communication module 150. The third version information of the payment app 111 may be information determining payment scenario information. A procedure for transmitting the third information of the payment app 111 may be integrated with a procedure for providing the second information of the payment app 111.

To use an electronic payment function, the UI information may be used to create a UI based on service scenarios and service information of the target store.

In a fourth step (S240), the controller 140 of the electronic payment device 120 may create the UI based on the UI information provided from the server 200. The controller 140 may create the UI through the head unit 130.

The UI may include product information and price information of the target store. Furthermore, the UI may be created based on service scenarios such as limiting the number of products to be purchased, purchasing methods, and whether coupons are used.

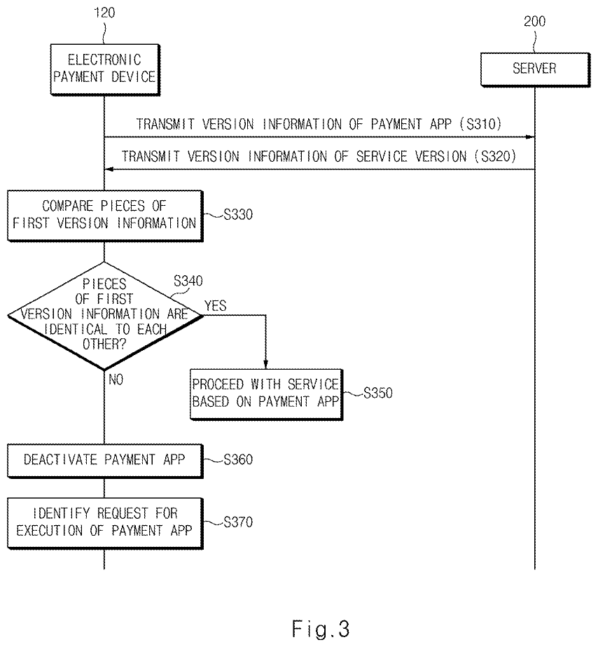

FIG. 3 is a flowchart illustrating an electronic payment method, according to another embodiment of the present disclosure. In detail, FIG. 3 describes a procedure in which a payment app is deactivated.

Referring to FIG. 3, in S310, the electronic payment device 120 may transmit version information of the payment app 111 to the server 200 through the communication module 150. When the first version information (X) of the payment app 111 is 1, the second version information (Y) is 1, and the third version information (Z) is 0, the electronic payment device 120 may transmit version information of (1, 1, 0) to the server 200. The electronic payment device 120 may transmit version information of the payment app 111 in response to an ignition-on (IG-ON) signal. A procedure in which the electronic payment device 120 transmits version information of the payment app 111 to the server 200 may be considered as including a procedure of making a request for version information of the service version 211 to the server 200. That is, the electronic payment device 120 may make a request for version information of the service version 211 to the server 200 in response to the ignition-on signal.

In S320, the server 200 may transmit the version information of the service version 211 to the electronic payment device 120. When the first version information (X) of the service version 211 is 2, the second version information (Y) is 1, and the third version information (Z) is 1, the server 200 may transmit the version information of (2, 1, 1) to the electronic payment device 120.

In S330 and S340, the controller 140 of the electronic payment device 120 may determine whether the first version information (X) of the payment app 111 with the first version information (X) of the service version 211, by comparing the first version information (X) of the payment app 111 with the first version information (X) of the service version 211 received from the server 200.

When the first version information (X) of the payment app 111 is the same as the first version information (X) of the service version 211 received from the server 200, in S350, it is possible to proceed with the payment service using the payment app 111.

When the first version information (X) of the payment app 111 is different from the first version information (X) of the service version 211 received from the server 200, the electronic payment device 120 may determine to deactivate the payment app 111 in S360.

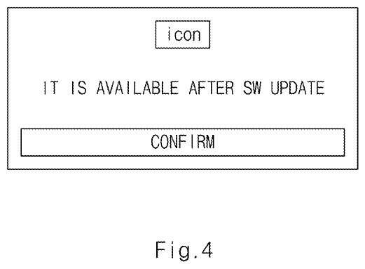

In S370, when the payment app 111 is requested to be executed by a user in a state where the payment app 111 is inactive, the electronic payment device 120 may inform that it is impossible to use the payment app 111, through the head unit 130. FIG. 4 is a diagram illustrating an embodiment of a notification that it is impossible to use the payment app 111.

Moreover, when the first version information (X) of the payment app 111 is different from the first version information (X) of the service version 211 of the server 200, the electronic payment device 120 may display a message indicating the recommendation of a software update, as shown in FIG. 4, through the head unit 130.

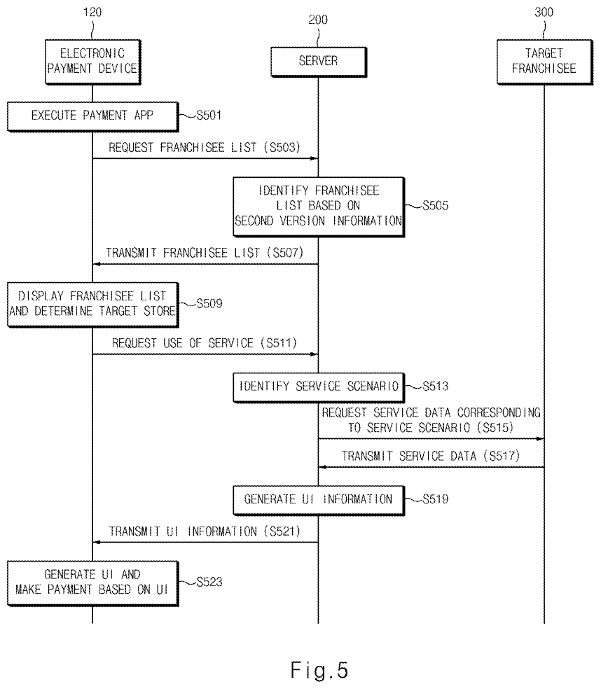

FIG. 5 is a flowchart illustrating an electronic payment method, according to another embodiment of the present disclosure. In detail, FIG. 3 describes a procedure in which a payment app is activated. That is, FIG. 5 illustrates a specific embodiment of S350 shown in FIG. 3. Hereinafter, a procedure of FIG. 5 will be described on the premise of S310 to S340 of FIG. 3. Referring to FIG. 5, a procedure of making an electronic payment based on a payment app is as follows.

In S501, the electronic payment device 120 may execute the payment app 111 based on a user input.

In S503, the electronic payment device 120 may make a request for a franchisee list to the server 200 based on a fact that the payment app 111 is executed.

In S505, the server 200 may identify the second version information (Y) of the payment app 111 received from the electronic payment device 120 in response to a franchisee list request from the electronic payment device 120. Moreover, the server 200 may search for the franchisee list matching the second version information (Y) of the payment app 111 and may generate the franchisee list based on the found result.

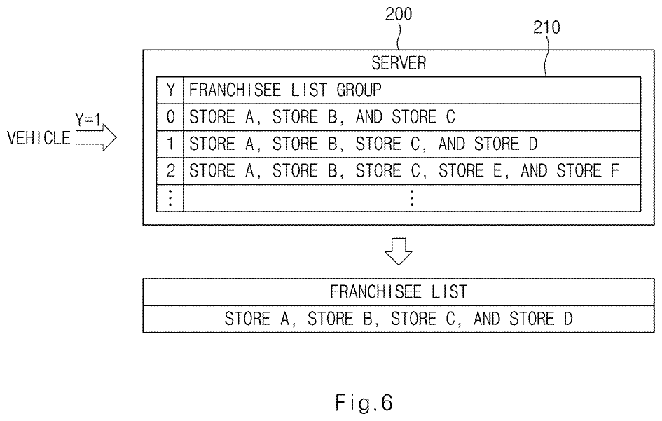

FIG. 6 is a view for describing a method in which a server generates a franchisee list.

Referring to FIG. 6, the server 200 may store a franchisee list group in the DB 210. The franchisee list group may include store information matching the second version information (Y). For example, franchisee information having “Y=0” may include store A, store B, and store C. The franchisee information having “Y=1” may include store A, store B, store C, and store D, and the franchisee information having “Y=2” may include store A, store B, store C, store E, and store F.

The server 200 may identify the second version information (Y) of the payment app 111 received from the electronic payment device 120. When the second version information (Y) of the payment app 111 is 1, the management device 220 of the server 200 may extract store information matching “Y=1” from the franchisee list group.

Moreover, the management device 220 of the server 200 may generate the extracted list including store A, store B, store C, and store D as a franchisee list.

In S507, the server 200 may transmit the generated franchisee list to the electronic payment device 120.

In S509, the electronic payment device 120 may display the franchisee list through the UI to determine the target store. The target store may be determined by user selection, and may be a franchisee that desires to purchase goods or services through an electronic payment.

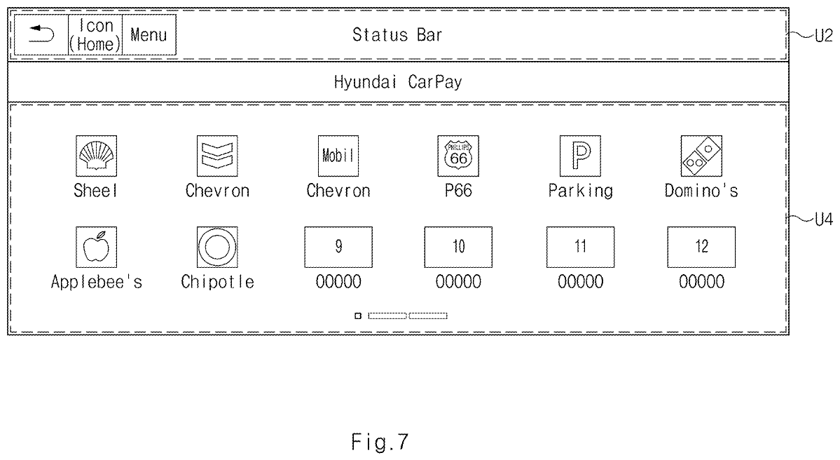

FIG. 7 is a view illustrating an embodiment in which an electronic payment device displays a franchisee list.

Referring to FIG. 7, the electronic payment device 120 may display a franchisee list through the head unit 130. The head unit 130 may display an input window control means through a second window U2. Furthermore, the head unit 130 may display franchisee information belonging to the franchisee list through a fourth window U4. The franchisee information may include a store name and a store image matching each store name.

In S511, the electronic payment device 120 may request the use of a service for the selected target store. The service use request for the target store may be determined based on a user input. For example, the electronic payment device 120 may identify a touch input of a touch display of the head unit 130 and may identify a franchisee corresponding to an icon of the franchisee list for which the touch input is made. The electronic payment device 120 may transmit the service use request for the target franchisee identified through the touch input to the server 200.

In S513, the server 200 may identify the service scenario. The server 200 may identify a scenario, which is capable of being serviced in the payment app 111, based on third information of the payment app 111 received from the electronic payment device 120.

For example, when the third version information (Z) of the payment app 111 is 0, and the third information of the service version 211 is 1, the server 200 may consider only the service scenario corresponding to “Z=0”.

In S515, the server 200 may make a request for service data corresponding to a service scenario to the franchisee 300 corresponding to the target store. That is, the server 200 may make a request for a service scenario corresponding to “Z=0” to the franchisee 300 based on a fact that the third version information (Z) of the payment app 111 is 0.

In S517, the franchisee 300 may transmit the service data to the server 200. The service data may transmit the service data corresponding to a payment scenario of the franchisee 300. The service data may include payment scenario information, menu information, price information, store information, and the like.

To this end, the franchisee 300 may have the service data corresponding to pieces of third version information (Z). That is, the franchisee 300 may have service data corresponding to “Z=0” and service data corresponding to “Z=1”. For example, a payment scenario corresponding to “Z=0” may be a method in which only a single order is possible, and a payment scenario corresponding to “Z=1” may be a method in which a payment for multiple orders is possible. When the third version information (Z) of the payment app 111 is 0, the franchisee 300 may transmit service data corresponding to a scenario in which only a single order is possible.

In S519 and S521, the server 200 may generate UI information based on the service data provided from the franchisee 300. Besides, the server 200 may transmit UI information to the electronic payment device 120.

In S523, the electronic payment device 120 may generate the UI based on the UI information received from the server 200.

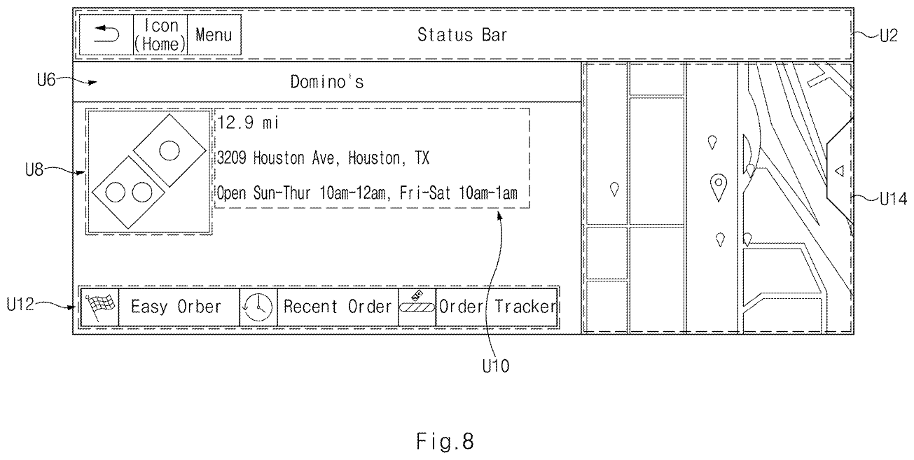

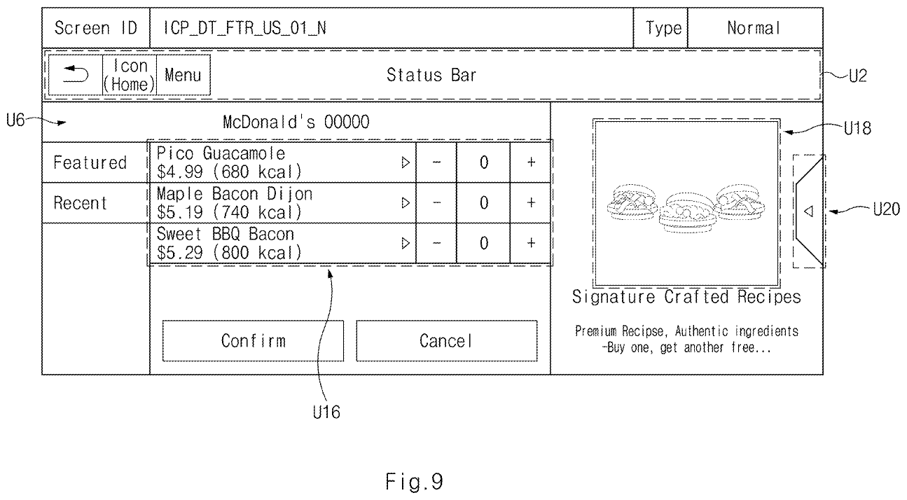

FIGS. 8 and 9 are diagrams illustrating an embodiment of a UI generated by the electronic payment device 120. FIG. 8 is a diagram illustrating a UI generated based on “Z=0”. FIG. 9 is a diagram illustrating a UI generated based on “Z=1”.

Referring to FIG. 8, the electronic payment device 120 may display a first UI of a single order method through the head unit 130. The first UI may include a second window U2 for displaying an input window control means, a sixth window U6 for displaying a store name, an eighth window U8 for displaying a store image, a tenth window U10 for displaying store address information, and a twelfth window U12 for displaying an order method. In addition, the first UI may include a fourteenth window U14 for displaying location information of the electronic payment device 120 or location information of a store.

Referring to FIG. 9, the electronic payment device 120 may display a second UI in which a payment for multiple orders is possible, through the head unit 130. The second UI may include a second window U2 for displaying an input window control means and a sixth window U6 for displaying a store name. The second UI may include a sixteenth window U16 for selecting a plurality of menus. In addition, the second UI may include an eighteenth window U18 for displaying a menu image and a twentieth window U20 for providing an input window for searching for menu information.

In FIGS. 8 and 9, each of the windows may include a function of a user input device receiving a user input based on a touch input as well as a function of displaying franchisee information.

The electronic payment device 120 may display a UI through the head unit 130 and may make an electronic payment based on a user input entered into the UI.

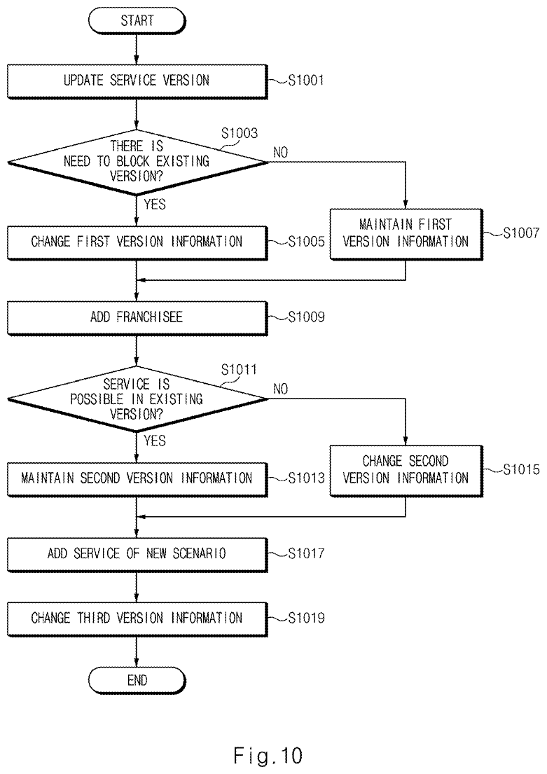

FIG. 10 is a flowchart illustrating a method for managing version information of a service version for an electronic payment, according to an embodiment of the present disclosure. FIG. 10 illustrates a method of managing version information of a service version based on an update of the service version of a server.

Referring to FIG. 10, in S1001, a method for managing version information of a service version according to an embodiment of the present disclosure may update a service version through the management device 220.

In S1003, it may be determined whether there is a need to block the service version of the existing version. The service version of an old version may be blocked when it is necessary to prohibit the use of the existing service version due to a fatal error or a change in supplementary policy.

In S1005, when there is a need to block the service version of the existing version, the first version information (X) of the service version may be changed through the management device 220. For example, the first version information (X) of the service version may be increased by 1.

In S1007, when there is a need to block the service version of the existing version, the first version information (X) of the service version may be still maintained.

In S1009 and S1011, it may be determined whether a service is possible in the payment app 111 of the existing version, based on a fact that a franchisee is added. For example, coffee shop A and coffee shop B may be included in the franchisee list group of the existing service version, and coffee shop C may be added in S1009. S1011 may correspond to a determination as to whether an electronic payment for coffee shop C is capable of being made in the existing payment app 111. To this end, it is possible to identify a payment scenario of coffee shop C.

In S1013, when the added franchisee is capable of providing a service through the payment app 111 of the existing version, the second version information (Y) may be maintained. For example, when coffee shop C has the same payment scenario as coffee shop A or coffee shop B, but has only menu information and price information different from those at coffee shop A or coffee shop B, it is possible to make a payment at coffee shop C through the payment app 111 of the existing version. As such, when it is possible to make an electronic payment for the added franchisee based on the existing payment scenario, the second version information (Y) of the service version may be maintained.

In S1015, when the added franchisee is incapable of providing a service through the payment app 111 of the existing version, the second version information (Y) may be changed. Accordingly, in S503 of FIG. 5, when the electronic payment device 210 requests the franchisee list, the server 200 may not include the franchisee that is newly added to the franchisee list.

In S1017, a new payment scenario may be added to the service version of the server 200.

For example, in an order method, the order and payment scenario in a drive-through manner may be newly added.

In S1019, when a new payment scenario is added to the service version of the server 200, the third version information (Z) may be changed through the management device 220.

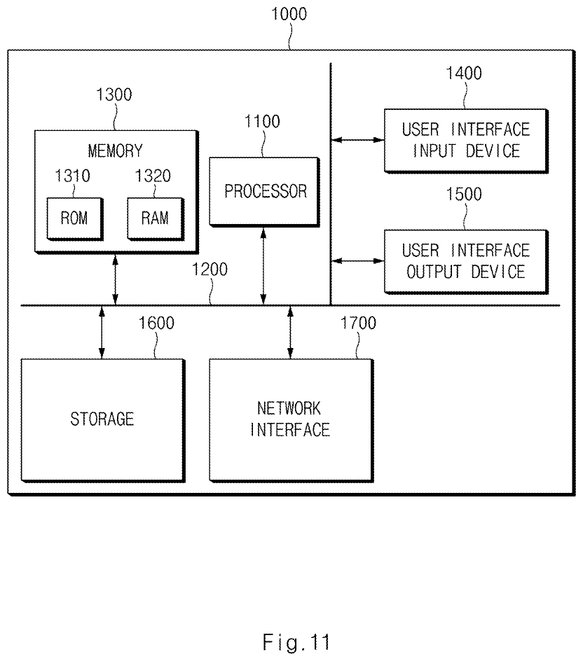

FIG. 11 is a block diagram illustrating a computing system, according to an embodiment of the present disclosure.

Referring to FIG. 11, a computing system 1000 may include at least one processor 1100, a memory 1300, a UI input device 1400, a UI output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. In detail, the processor 1100 according to an embodiment of the present disclosure may perform a function of the controller 140 shown in FIG. 1. Each of the memory 1300 and the storage 1600 may include various types of volatile or nonvolatile storage media. For example, the memory 1300 may include a read only memory (ROM) and a random access memory (RAM).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

According to an embodiment of the present disclosure, it is possible to provide an electronic payment procedure even when a server fails to upgrade a payment app, by identifying and managing version information of the payment app making an electronic payment.

According to an embodiment of the present disclosure, when a franchisee that provides a service is added, even though the payment app does not have information about the added franchisee, it is possible to make an electronic payment.

Besides, a variety of effects directly or indirectly understood through the specification may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for an electronic payment, the apparatus comprising:
a head unit configured to provide a user interface (UI) of a payment app that proceeds an electronic payment; and
a controller configured to:
activate the payment app based on a fact that first version information of the payment app is identical to first version information of a service version stored in a server;
request a franchisee list, at which it is possible to proceed a payment with the payment app, to the server based on a fact that the payment app is activated;
request UI information of a target store selected from the franchisee list to the server;
generate a UI based on the UI information received from the server; and
proceed the electronic payment based on the UI displayed on the head unit.

2. The apparatus of claim 1, wherein the controller is configured to request the service version to the server and identify the first version information of the payment app and the first version information of the service version.

3. The apparatus of claim 2, wherein the controller is configured to provide a user of the payment app with a notification that it is impossible to use a payment function, based on that the first version information of the payment app is different from the first version information of the service version.

4. The apparatus of claim 2, wherein the payment app is installed in a vehicle, and
wherein the controller is configured to request the service version to the server in response to an ignition-on signal of the vehicle.

5. The apparatus of claim 1, wherein the controller is configured to request the franchisee list based on transmitting second version information of the payment app indicating franchisee information, which is available with the payment app, to the server.

6. The apparatus of claim 1, wherein the controller is configured to request UI information of the target store based on transmitting third version information of the payment app indicating a payment scenario, which is supportable in the payment app, to the server.

7. A server for an electronic payment, the server comprising:
a database (DB) configured to provide a space in which a service version supporting an electronic payment device using a payment app and information of a franchisee list group where franchisees are classified;
a management device configured to transmit first information of the service version for determining activation of the payment app to the electronic payment device and to extract a franchisee list from the franchisee list group in response to a franchisee list request from the electronic payment device; and
a UI generation device configured to receive information about a target store selected from the franchisee list from the electronic payment device, to generate UI information about the target store, and to provide the generated UI information to the electronic payment device.

8. The server of claim 7, wherein the management device updates first information of the service version to block service use for the payment app of an existing version.

9. The server of claim 8, wherein the management device identifies second information of the payment app received from the electronic payment device in response to the franchisee list request and extracts a franchisee list, which matches second version information of the payment app, from the franchisee list group.

10. The server of claim 9, wherein the management device updates second version information of the service version based on a fact that a new franchisee in the franchisee list group is not capable of being serviced in the payment app.

11. The server of claim 7, wherein the UI generation device generates the UI information based on third version information of the payment app indicating a payment scenario, which is supportable in the payment app.

12. The server of claim 11, wherein the UI generation device requests a service data to the target store and generates a UI based on the payment scenario and the service data of the target store.

13. An electronic payment method, the method comprising:
activating a payment app based on a fact that first version information of the payment app for an electronic payment is identical to first version information of a service version stored in a server;
requesting a franchisee list, at which it is possible to proceed a payment in the payment app, to the server based on a fact that the payment app is activated;
receiving the franchisee list and requesting UI information of a target store selected from the franchisee list to the server; and
generating a UI based on the UI information received from the server and proceeding an electronic payment based on the UI.

14. The method of claim 13, wherein the activating of the payment app includes:
requesting the service version to the server; and
identifying the first version information of the payment app and the first version information of the service version.

15. The method of claim 14, wherein the identifying of the first version information of the service version further includes:
providing a user of the payment app with a notification that it is impossible to use a payment function, when the first version information of the payment app is different from the first version information of the service version.

16. The method of claim 14, wherein the making of the request for the service version to the server is performed in response to an ignition-on signal of a vehicle in which the payment app is installed.

17. The method of claim 13, wherein the making of the request for the franchisee list includes:
transmitting second version information of the payment app indicating franchisee information, which is capable of being used by the payment app, to the server.

18. The method of claim 17, wherein the franchisee list is generated by extracting a franchisee list matching the second version information of the payment app from a franchisee list group stored in the server.

19. The method of claim 13, wherein the making of the request for the UI information of the target store includes:
transmitting third version information of the payment app indicating a payment scenario supportable in the payment app.

20. The method of claim 19, wherein the UI is generated based on the payment scenario and service data of the target store.
